(19) United States
(12) Patent Application Publication
(10) Pub. No.: US 2009/0228554 A1
(43) Pub. Date: Sep. 10, 2009

(54) Method and system for assigning unique and dynamic information-carrying serial numbers

(75) Inventors: Nima Veiseh, New York, NY (US); David W. Baarman, Fennville, MI (US); Thomas Jay Leppien, Grand Haven, MI (US)

Correspondence Address: ALTICOR INC., 7575 FULTON STREET EAST MAILCODE 78-2G, ADA, MI, 49355, US

(73) Assignee: Access Business Group International LLC

(21) Appl. No.: 12/074,499

(22) Filed: Mar. 4, 2008

(51) Int. Cl. G06F 15/16; G06F 15/173

(52) U.S. Cl. 709/204; 709/224

(57) ABSTRACT

A method and system for assigning unique static and dynamic information-carrying serial numbers is disclosed. The static portion of the serial number is assigned before the device enters service, such as at assembly. A serial number computer is used to store the static and dynamic serial number, such as an EEPROM. The computer is integrated into a device, or is fixedly connected to a device, such that computer has access to the sensors and other input devices contained with the device. Data from the sensors and input devices is processed by the computer and is converted into a numerical format, comprising the dynamic portion of the serial number. The computer then connects to the Internet, such as through a wireless connection, and communicates the serial number to authorized users. Alternatively, authorized users may seek out the device on the Internet and obtain the information contained in the serial number, converted to a webpage format. The data collected can also be used for research purposes, such as usage, durability, and other uses.

### BACKGROUND OF THE INVENTION

Objects, products, or devices are commonly assigned serial numbers by their manufacturers for a variety of reasons. Tracking the date of manufacture, location of manufacture, country of origin, and model number are only several common examples of serial number uses. These numbers are usually printed on stickers or labels, and affixed to a product, and also can be duplicated on exterior packaging, so that the contents of the packaging can easily be identified. In other cases, serial numbers are physically printed or engraved onto a product, using ink, laser etching, or some other permanent or semi-permanent process.

Usually, these serial numbers are intended to remain attached or affixed to the object and its packaging for the life. In fact, many serial numbers are purposely difficult to remove, to prevent a user or other person from separating this information from the product, which the manufacturer deems to be critical or is required. The reasons for this are several. First, the product may be intended for certain markets, and these products may not function properly if they are used in unintended markets. One common example is the unique electrical plugs and voltages used around the world. Second, the product may have an expiry or use-by date that the manufacturer wishes to communicate to the user. Third, the manufacturer may need to recall products or issue updates for a product, and these updates may only apply to a production run of a set of serial numbers, but not those outside the set. Finally, the manufacturer may desire to have internal testing or other quality assurance programs run on products and the serial number can provide critical information as to time of manufacturer, machine used, and so forth.

However, serial numbers as used previously have several limitations. First, the serial number is fixed as soon as it is applied. No changes can be made to the serial number and the product cannot update the serial number on its own. Second, the serial number has no communication ability to other devices, particularly no wireless communication ability. Third, the serial number has no encryption or security features built into it. Once the layout of a serial number is known, anyone can interpret the serial number. For example, the Vehicle Identification Number (VIN) system used on automobiles is widely known and can be found on the Internet. One can simply use the VIN to determine the make, model, engine size, color, date and place of manufacture, among other pieces of information. Further, a static serial number cannot be updated during manufacture, for example. As a product is being assembled, a serial number cannot be changed in real-time, to reflect its current state of assembly or condition. For example, a serial number can denote that the product has not yet passed quality control.

What is needed then is a method and system for assigning unique and dynamic information-carrying serial numbers to objects/products to identify the product, but also to communicate the current state of the object wirelessly to designated receivers. This improved method and system will have not only standard serial number information, such as model number, date of manufacture, but also due to its integral data connection to the product, the system is able to report on the current operating state of the product obtained by the Serial Number Computer. The Serial Number Computer (SNC) contains standard computer hardware, including a micro-controller, a power source, memory (such as EEPROM —Electrically Erasable Programmable Read-Only Memory), and wireless communication ability. The SNC is synergistically connected to a product, either physically or remotely. For example, the SNC determines and communicates wirelessly to a receiver that the product is operating correctly and in the case of a water filtering product, displays and communicates that the product's filter has 50% life remaining, or other operational information.

The SNC's wireless communication has several features. First, the SNC's wireless communication is also secured by encryption, so that only those authorized to receive the communication are able to do so. Second, since the SNC is able to wirelessly communicate to a receiver, the product can be tracked from the source plant all the way to the purchaser of the product. A manufacturer, for example, is then able to acquire a real-time inventory and the locations of all products, either sold or in stock at various locations. The SNC may also be used in conjunction with a serial number such as in a tag or label format. Finally, the product's software programming may be upgraded using the present invention by a data link between the SNC and its product. As the manufacturer, for example, queries the product, the dynamic portion of the serial number may identify a software level. If this software level is not the most current, the manufacturer may send a new program wirelessly to the SNC, which then uploads the software into the product's hardware.

### SUMMARY OF THE INVENTION

In view of the above, the present invention provides a method and system for assigning unique and dynamic information-carrying serial numbers wirelessly to objects/products/devices. A first part of a serial number is assigned to a product at its creation and is called the static portion of the serial number. The static portion of the serial number remains constant throughout the life of the product. Information contained therein includes the product's model number, date of manufacturer, location of manufacture, and so on. A second, dynamic part of a serial number changes over time as a result of the state of the product and is called the dynamic portion. Information contained therein includes changing data such as product usage meter, filter life remaining, power consumption, and diagnostic trouble codes.

The completed serial number (static and dynamic portions) is stored in the SNC, which assigned to a product with the recently-created serial number. The SNC may be integrated into a product, such as a hard-wired installation, or be included as a component of the product, such as on a circuit board or as a plug-in module. The SNC may be located such that a portion of the SNC is viewable by a product user, such as occupying a portion of the external surface of the product. In other applications where an internal installation is not feasible or desired, the SNC may be located near the product, and utilize a short-range wired or wireless communications system, such as infrared or using radio frequencies. Alternatively, a hard-wire cable or conduit may also be used to link the SNC to its product.

Once the SNC is mated to the product, according to the present invention, wireless communication of the serial number between the product and manufacturer (or other authorized party) thus identifies the product's initial creation state and its dynamic state at that time. The SNC can be instructed to contact at designated intervals, such as monthly, yearly, upon occurrence of a specific event, or when the product requires servicing. Alternatively, the manufacturer or other designated party can reach out and contact the SNC, using wireless or wired communications, requesting certain information, such as usage, consumable component life remaining, or for other pertinent information.

The present invention insures that all necessary information pertaining to the product is carried in one compressed and encrypted packet of data which is then safely and securely communicated wirelessly. The transmission of data occurs silently and without disrupting operation of the product. The seamless operation of the present invention is highly desirable, as disturbances to the customer/end user are to be avoided. Additionally, the privacy of the customer/end user is preserved as the encrypted data can only be interpreted by those parties who have the encryption codes.

The present invention also allows for improved tracking of products throughout the manufacturing, retailing, and end user acquisition and operation. Once the SNC is mated or assigned to a product, it can be contacted as much or as little as desired. For example, a manufacturer can determine how many units of a particular type of product are stored in its warehouse. A distributor can determine how many products are being used by customers, and how often. This information can be used to tailor products and services to customers based on actual use rather than perceived or estimated use.

In one embodiment of the present invention, a first (static) portion of a serial number is assigned to an object/product/device during the manufacturing process. This assignation may occur when a critical number of components of the product are reached, or when a first component is joined to a second component of the product. Additionally, this first part of a serial number may be assigned at the completion of the product, or at any time during its manufacture. This first part of the serial number allows for the manufacturer to track the product through the assembly process by wireless communication through the SNC, integrally a part of the device. Since the SNC has a wireless communication connection, the manufacturer can locate and query the SNC from a remote location. Once accessed, the manufacturer is able to assign a static portion of the serial number which remains with the SNC and its device.

In order to assign a static portion of a serial number, the SNC must be powered. This power can come from the product's power supply or can be from the SNC's internal power supply. A wireless signal is sent which is received by the SNC. As the manufacturer is aware of the exact identity of the SNC (it having been assigned an identification (ID) and is staged in the assembly process) to be used with a particular device, the message arrives only at the SNC being installed in the appropriate device. At that point the SNC has a serial portion of a serial number and a dynamic portion (indicating undergoing assembly, etc.).

In another embodiment of the present invention, a dynamic portion of a serial number is assigned to an object/product/device. This assignation may occur at any point during the manufacturing process or after the product is completed. This dynamic portion stores the current state of the product and is communicated by the SNC through wireless communication to a designated receiver. For example, if the dynamic part is assigned during manufacture, the dynamic portion of the serial number will indicate the product is not yet complete. Once the product is completed, the dynamic part of the serial number will then be wirelessly communicated by the SNC stating that the product has been completed and is ready for use. If the product requires maintenance or service, for example, the dynamic portion of the serial number will change to indicate that such a condition currently exists with regard to the product. The SNC then wirelessly communicates that information to the manufacturer or other approved party.

In another embodiment of the present invention, the wireless information communicated by the SNC is contained in a compressed data packet which includes encryption to secure the data to prevent unauthorized reception of the data during wireless transmission. The system and method of encryption is disclosed in U.S. Pat. App. 2006/0190728, which is hereby fully incorporated by reference.

In another embodiment of the present invention, the system of serial numbers and SNCs allows for the tracking of many multiples of objects/products assigned SNCs according to the present invention. The manufacturer is able to track assigned products through the assembly process, post-assembly, distribution, and end user location and usage. The system provides for real-time tracking of all assigned serial numbers via their SNCs which are capable of wireless Internet communication. As such, the manufacturer can determine precisely where a day's production run is located, even after a long period of time has elapsed since that day's production. This knowledge can enable the manufacture to send a software upgrade, for example, or other communication to end users, or instructions to distributors regarding those particular products, wirelessly to the SNCs integrally part of the devices.

In another embodiment of the present invention, the system and method provides for tracking, monitoring, and controlling of appliances within a home. Every appliance within the home is equipped with a SNC, containing static data such as date of manufacture, and dynamic data, such as hours of operation. All appliances within the home would then be wirelessly connected via the Internet to their manufacturers and the SNC then communicates at set intervals with the manufacturers to verify if any parameters in the dynamic data portions change beyond acceptable limits. For example, if a portion of the dynamic serial number contained within the SNC reaches “10”, the SNC determines that the filter has nearly been filled to capacity. The SNC then contacts the manufacturer or other supplier through the Internet and requests a new filter replacement be sent to the device's location. When the owner installs the new filter, the SNC detects a new filter and resets that portion of the dynamic serial number to “99” and notifies the manufacturer through the Internet of this new filter condition. If the owner did not change the filter, and the serial number decreased to “00”, the SNC then notifies the manufacturer and the owner is contacted to verify that a filter was received, and inquires if assistance is requested (e.g., help installing the filter).

It will be readily understood that the components of the present invention, as generally described and illustrated in the figures herein, may be arranged and designed in a wide variety of different configurations. Thus, the following more detailed description of the embodiments of the apparatus, system, and method of the present invention, as represented in figures, is not intended to limit the scope of the invention, as claimed, but is merely representative of selected embodiments of the invention.

Reference throughout this specification to “one embodiment” or “an embodiment” (or similar) means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples, etc., to provide a through understanding of embodiments of the invention. One skilled in the art will recognize, however, that the invention can be practiced without one or more of the specific details, or with other methods, components, materials, etc. In other instances, well-known structures, materials, or operations are not shown or described in detail to avoid obscuring aspects of the invention.

### BRIEF DESCRIPTION OF THE DRAWINGS

FIG. 1 is a schematic of one embodiment of the present invention.

FIG. 2 is a schematic of another embodiment of the present invention

### DETAILED DESCRIPTION OF THE INVENTION

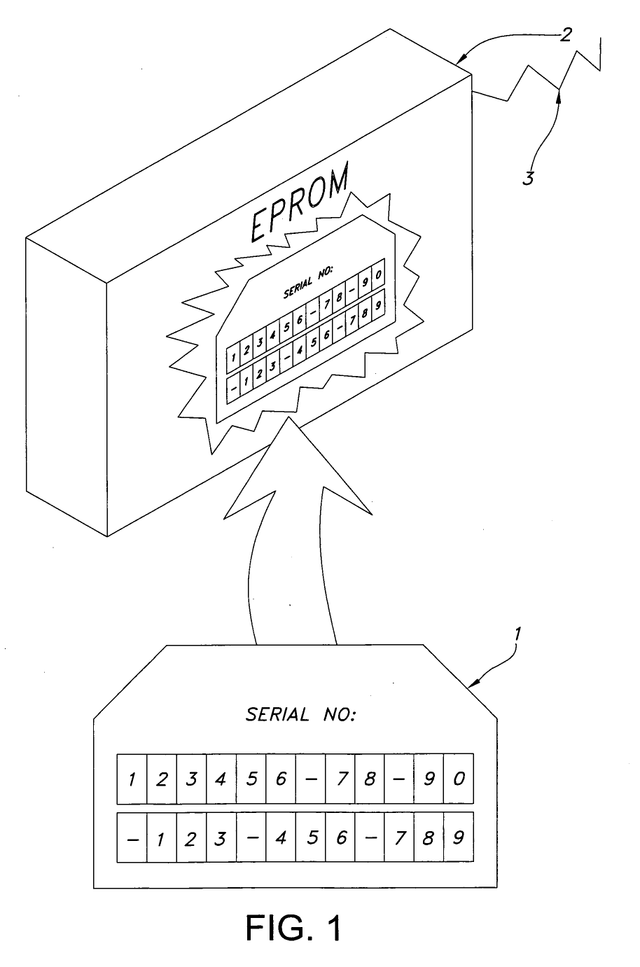

Referring now to FIG. 1, a schematic of the present invention is shown. Serial number 1 is electronically stored in SNC 2, which wirelessly connects to the Internet 3. The present invention provides the wireless communication of information easily, safely, and efficiently from objects/products/devices equipped with a SNC according to the present invention. The SNC according to the present invention wirelessly communicates the creation data, usage data, malfunctions, and other data which is stored in the serial number on a real-time basis. The SNC is capable of processing and storing data, hosting a webpage, and operates as a computer server functions. It contains an internal power supply or uses power available to the host object, where applicable. The SNC further contains an antenna to allow it to access the Internet wirelessly (or via a wired Internet connection if necessary), a processor with memory, and a plurality of sensors. Additionally, the SNC may be equipped with a variety of inputs to receive data from the object, where applicable. For example, the SNC may receive the input via data link from a temperature sensor or flow meter that is integral to its host object/device. This data link enables data to flow from the product to the SNC and the reverse. This link allows for the product software to be updated remotely, without user interaction, for example. Additional product data may be obtained, diagnostics performed, or other product-specific tasks using the SNC as a conduit to the product by a host server, such as one located or operated by the object/device manufacturer, a local utility provider, or product fulfillment service.

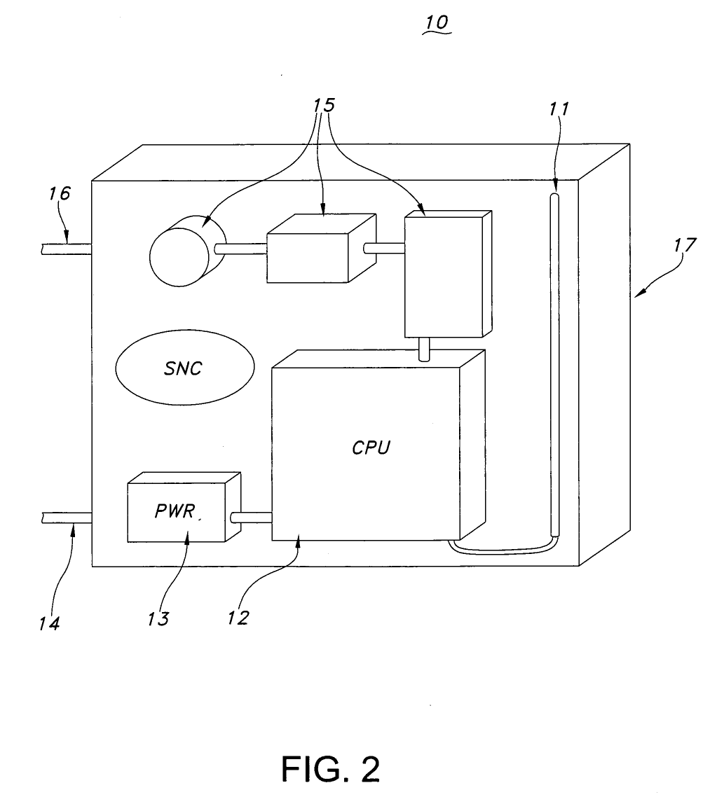

FIG. 2 illustrates a component view of the SNC 10. Antenna 11 is connected to CPU 12, and is primarily used for wireless communication of data to and from the SNC 10. CPU 12 received power from power supply 13, which may be either a battery, rechargeable or standard, may be a direct connection as shown via power cable 14 to the host device power supply, or may receive power wirelessly, such as via inductive power or RFID type power transmission. A wired communication connection may be optionally included (not shown). CPU 12 analyzes and processes data received from sensors 15 and input devices connected to SNC 10 via input cable (data link) 16. Such onboard sensors could include temperature, location (via GPS), power current usage, or other parameters appropriate to the particular device. Input devices (not shown) connected to input cable 16 may provide other appropriate data that the product generates, such as filter life remaining, volume of water treated, UV bulb life, etc. These data are preferably gathered using the product's own circuitry and internal systems, and tapping into these systems avoids duplicating them within the SNC 10. CPU 12 also encrypts data transmitted using antenna 13, so only authorized users may access the data, whether the data is used by the product's owner, or the device manufacturer, or some other approved user, such as for data collection for market research or other surveys.

The first portion of the serial number, the static portion, is assigned during manufacture or at some other point determined to be appropriate, but it is preferred to assign the static portion as the device/product, for example, a water treatment system, is “born” and becomes a complete unit. At that point, the SNC has been joined to or is an integral part of the unit. Using the SNC's onboard power supply, or the unit's power supply—for example, when the unit is quality-control checked—the SNC receives a wireless message from the manufacturer assigning its static and dynamic serial numbers. The static number includes information such as the unit's model number, build data, etc. The second, dynamic portion includes such information as the condition of the unit—new, quality control check, etc. Each portion of the serial number is a collection of numbers which the SNC converts, using the markup language previously disclosed in the co-pending application referenced above, into readable language that is presentable in a webpage format. This serial number information is easily encrypted and sent using small data packets, so each communication is small, and a large volume of communications is therefore not burdensome to Internet capacities.

As the SNC obtains the data from the object/product, the manufacturer, for example, can learn its current status using its own host server in webspace. For example, if the manufacturer issues a software upgrade, the serial number for all concerned products is already known to the manufacturer and those products requiring the upgrade will receive the upgrade wirelessly and without the end user being inconvenienced, distributed by its host server. Further, if the product requires a consumable component, such as a filter, the SNC will obtain from the product the filter's current status, and communicate that information to the manufacturer. Once the filter has been depleted to a set level, the manufacturer can direct a replacement be sent to the product user's address, again without inconveniencing the end user.

One advantage of the present invention is the encryption of the data processed in the SNC that is wirelessly transmitted. A wired communication connection is optionally provided, for situations where wireless communication is not available. If the wireless transmission involves the Internet, the Internet Protocol (IP) address is disclosed during wireless communication, but this does not by itself disclose any confidential information. Rather, the IP address simply allows the manufacturer to locate the product in webspace and record its location as the SNC activates, establishes an Internet connection, and accesses the manufacturer's host server, having been provided its IP address as the SNC was assigned to its product (at assembly). By not including the IP address in the serial number, the actual packet size of data transmitted is reduced, improving speed and response time. If other forms of wireless communication are used, even if the signals are intercepted, the data encryption protects any sensitive or proprietary information from being misused.

Another advantage of the present invention is that the system can query any product equipped with a SNC and easily extract any information desired by the manufacturer. For example, the manufacturer may wish to determine the usage of the product since its activation. If the product has been heavily used, the manufacturer may choose to communicate with the product's end user concerning an upgraded product or for service or maintenance issues. As another example, if the product is malfunctioning, the manufacturer is immediately notified via the present invention and can dispatch appropriate service personnel to the product's location by contacting an affiliated repair service by phone, internet or other suitable communication means. If a consumable item used by the product is nearing exhaustion, the SNC communicates this data to the manufacturer who is then able to direct via phone, internet, or other suitable communication, a replacement consumable item be sent to the product's location using a product fulfillment service, parcel post, overnight delivery, for example.

Another advantage of the present invention is that the system uses the SNC to store both the static creation data of the product, such as date of manufacture, etc. but also stores dynamic data of the product, such as cycles of operation, power consumed, and other dynamic data generated by the product's operation. The dynamic data is updated in real-time, such that the manufacturer is alerted, in the example of a product malfunction, immediately. The present invention allows the manufacturer to access the product through the SNC's wireless connection and conduct diagnostic and other technical system maintenance on the product, all through the Internet and without requiring any input or effort from the end user.

The serial number stored in the SNC of the device according to the present invention is comprised of two portions. The first part is the permanent or static portion. This portion of the serial number does not change and is assigned to the product during manufacture, or at some other point chosen by the entity assigning the static serial number. The static portion generally carries four items (or bits) of information: the manufacturer; the time/date the product was made; place the product was made; and the product's model. This information is permanently stored in the SNC and is not changeable, but can be accessed at a later date to determine the identity of the device.

The second part is the dynamic portion pertaining to the current state of the product. At the initial period, when the static portion is assigned, the dynamic portion is set to null, or all zeros. When the product is able to determine its own status, for example, its first power-up, a number of data bits would then be determined and communicated by the present invention. Sensors connected to the SNC provide dynamic status data which is then converted into the serial number format according to instructions previously installed in the SNC. For example, in the case of a water treatment system, there could be an additional eight bits of information: age or particulate filter; date made; activation date; usage; total time in use; percentage used; geographic location; and any diagnostic codes for malfunctions (if any). One number could be assigned to record filter life, for example, “0” could correspond to 100% life, “9” could correspond to 0% life. This assignment of a number value necessarily varies depending upon the application device. Several digits could be used, rather than one, to indicate gallons of water treated, or some other cycle period that is appropriately measured depending on the device.

The combined string of data bits containing both static and dynamic data is compact, portable, and easy to transmit wirelessly. Additionally, the small data packet size is ideal for hi-bit encryption techniques, such as those disclosed above. Due to the small packet size, the bandwidth requirements for a manufacturer to collect data on a large number of products, for example, 500,000 units, it relatively small. For a manufacturer monitoring many products of such production volume does not place undue demands upon the manufacturer's bandwidth.

The serialization method is a two-step process. For the purposes of illustration, a water treatment system will be used. In this example, the assigned serial number will use twelve bits of information, stored in the SNC of the present invention.

The first step requires the embedded, permanent (static) birthmark of the product to be added to the front of a serial number. In this example the static portion carries four bits of information: 1) manufacturer name; 2) date/time of manufacture; 3) location of manufacture; and 4) the exact model type. This static portion of the serial number will take the following format:
xx-xxxxxx,xxxxxx-xx-xxxx.

Manufacturer is denoted as the first two digits. Date/time of manufacture will be denoted as the next twelve digits. Date is denoted as year, month, day (for example 070829 for Aug. 29, 2007). Time is denoted as hour, minute, second (for example, 235502 for 11:55.02 pm). The next two digits are denoted as the plant location (for example, P1 for Plant #1). The final four digits are denoted as the exact model type (for example, DE02 for Deluxe model 2).

The second step requires the dynamic portion of the serial number to be generated and added to the static portion to create a complete serial number. Again, using the same example of the water treatment system, eight more bits of information are included: 1) age of particular filter; 2) date of make; 3) date of activation; 4) number of individual times used; 5) time of use; 6) percentage used; 7) geographic location; and 8) any diagnostic codes signaling malfunctions. The dynamic portion of the serial number takes the following format:
xx-xxxxxx-xxxxxx-xxxxx-xxx:xx:xx-xx-xx-xx.

Age of particular filter is denoted as the first two digits (for example 32 for 32 months). Date of make is denoted by the next six digits (for example, 070829 for Aug. 29, 2007). Date of activation is denoted by the next six digits (for example, 070829 for Aug. 29, 2007). Number of times used is denoted by the next five digits (for example, 12000 for 12,000 times used). Total time used is denoted as the next seven digits (for example, 120:10:00 for 120 hours, 10 minutes, and 0 seconds). Percentage used is denoted as the next two digits (for example, 76 for 76% used). Geographical location will be denoted as the next two digits (for example, MI for Michigan). Diagnostic codes will be denoted as the final two digits (for example, 02 for low water supply pressure).

The SNC is optionally connected to the device's control systems, which allow it to access sensors, data and parameters which the device uses to achieve its task. For example, in the case of a water treatment product, the sensors detect the water supply pressure, water flow rate, and filter usage. Data is the numerical values of the sensor readings and parameters are set in controls of the device, which trigger either an error code (generated and read by the SNC) or an “OK” code, which is also read by the SNC but does not trigger a negative response.

In either case, the SNC wirelessly connects to the Internet and reports the status of the device to the host server at regular intervals, which are preset by the manufacturer as the SNC is initiated. These intervals can be changed by the manufacturer as desired. For example, if the SNC is configured to contact the manufacturer every 250 device cycles, the manufacturer may wish to increase the frequency of contact to every 100 cycles in order to study the performance of the device. This variable sampling rate is useful when studying a new product, or a new market introduction, for example.

Thus, in this embodiment, 46 individual digits contain a sizeable amount of data pertaining to the water treatment product from where the product was made, to how much of the filter has been used to date. If the 46 digits are too large for some applications, algorithms can be used to reduce the size of the data packet as desired. It is recommended to use 64-bit encryption which uses two 32-digit prime numbers to provide adequate privacy protection of the encrypted information.

The third step is the encryption and transmission of the data packet created above. Using the encryption method listed above, the data packet is encrypted and sent wirelessly through the Internet. While the IP address of the sender (end user) is inherently given during data transfer, there is no security compromise of the data packet. The IP address simply allows the manufacturer to find the product and log its present position in webspace. By not including the IP address of the product itself in the serial number, the size of the packet is not increased.

Another embodiment of the present invention is a 46-digit serial number, in the format:
xx-xxxxxx,xxxxxx-xx-xxxx-xx-xxxxxx-xxxxxx-xxxxx-xxx:xx-xx-xx-xx

Forty-six individual digits as arranged above, are able to store and quantify a large amount of information about the device it is assigned to. Using simple codes to interpret numbers, as shown above, the amount of actual data transmitted is very small, yet concise. Further, the size of the 46-digit serial, as in any size serial number of the present invention, may be reduced by using algorithms to optimize their size. It is recommended to use 64-bit encryption technique involving two 32 digit prime numbers, but other encryption techniques may be used.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A system for assigning unique and dynamic information-carrying serial numbers to at least one object, said system comprising:
a static portion of said serial numbers;
a dynamic portion of said serial numbers;
a serial number computer (SNC) for electronically storing and wirelessly communicating said serial numbers; and
an encryption algorithm for securing wireless communication between said object and the Internet.

2. The system of claim 1, wherein said static portion contains data that is unchangeable once assigned to said object.

3. The system of claim 1, wherein said dynamic portion contains data that is variable depending upon the status of said object.

4. The system of claim 1, wherein said SNC is physically incorporated into said object.

5. The system of claim 1, wherein said SNC is a separate component, fixedly attached to said object.

6. The system of claim 1, wherein said serial numbers are data-compressed by said SNC to conserve bandwidth.

7. The system of claim 1, wherein said SNC communicates data to and from said object through the Internet.

8. The system of claim 1, wherein said SNC communicates with other SNCs using the Internet.

9. The system of claim 1, wherein said SNC communicates with host servers using the Internet.

10. The system of claim 1, wherein said SNC communicates using wireless communication systems.

11. The system of claim 1, wherein said SNC communicates using wired communication systems.

12. The system of claim 1, wherein said SNC further comprises a processor, memory, an antenna, data inputs, sensors, and a protective covering.

13. A method of assigning unique and dynamic information-carrying serial numbers to at least one object, said method comprising:
securing a SNC to said object;
assigning a static portion of said serial numbers containing creation data pertaining to said object;
assigning a dynamic portion of said serial numbers containing changeable data pertaining to said object;
obtaining data pertaining to said object from sensors and input devices;
processing data pertaining to said object;
encrypting said serial numbers for security purposes;
monitoring said serial numbers for changes to requiring action; and
communicating said serial numbers through the Internet to approved recipients.

14. The method of claim 13, wherein said SNC obtains assembly data, geographical location data, usage data, biometric data, performance data, and reliability data pertaining to said object from said sensors and input devices.

15. The method of claim 13, wherein said SNC obtains health information pertaining to said object.

16. The method of claim 13, wherein the communicating of said serial numbers are encrypted before data transmission.

17. The method of claim 13, wherein said monitoring of said serial numbers begins when said static portion is assigned to said SNC of a device.

18. The method of claim 13, wherein said object includes a product registration program whereby consumable components of said object are automatically replaced upon detection and wireless communication by said SNC.

19. The method of claim 13, further comprising an Internet-based device monitoring system, wherein authorized users can selectively access said object to obtain information stored in said SNC.

20. The method of claim 13, wherein said data is used to analyze and survey object usage, performance, and other attributes for research purposes.
